(19) United States
(12) Patent Application Publication
(10) Pub. No.: US 2023/0376607 A1
(43) Pub. Date: Nov. 23, 2023

(54) ANALYSIS APPARATUS, ANALYSIS SYSTEM, ANALYSIS METHOD, AND ANALYSIS PROGRAM

(71) Applicant: NEC CORPORATION, Minato-ku, Tokyo (JP)

(72) Inventors: Junpei KAMIMURA, Tokyo (JP); Kazuhiko ISOYAMA, Tokyo (JP); Yoshiakai SHKAE, Tokyo (JP)

(73) Assignee: NEC Corporation, Minato-ku, Tokyo (JP)

(21) Appl. No.: 18/034,536

(22) PCT Filed: Nov. 19, 2020
(86) PCT No.: PCT/JP2020/043262

§ 371 Date: Apr. 28, 2023

(51) Int. Cl. G06F 21/57

(52) U.S. Cl. CPC G06F 21/577; G06F 2221/033

(57) ABSTRACT

In order to determine whether or not there is a security risk, based on an actual data flow in a system to be analyzed, an analysis apparatus includes: a receiving unit configured to receive history information related to operation history of a program operating in a system to be analyzed; a generating unit configured to generate data flow information indicating a path of data exchanged in the system to be analyzed, based on the history information; and a risk determining unit configured to perform a risk determining process for determining whether or not there is a security risk in the data flow information, based on a preset determination condition.

### TECHNICAL FIELD

The present invention relates to an analysis apparatus, an analysis system, an analysis method, and an analysis program.

### BACKGROUND ART

Security enhancement of systems connected to networks has been desired in recent years, and services such as vulnerability diagnosis and penetration test are provided to analyze a security risk in a system.

The vulnerability diagnosis is a method of comprehensively grasping vulnerability inherent in a system and a lack of a security function, based on known definitions of vulnerability such as SQL injection and cross-site request forgery. The penetration test is a method of analyzing whether an attack on a system based on an attack scenario created in advance can achieve the purpose of the attack, to thereby grasp realizability of damage to the system.

Through the vulnerability diagnosis, it is possible to comprehensively verify the entire system but is difficult to grasp undefined vulnerability and the like. Through the penetration test, it is possible to verify a concrete method of accessing the system and the like. However, the penetration test has a problem of an increase in cost and time to comprehensively analyze the system. To address the problems, a security risk analysis technique focusing on data handling in a system has been proposed.

For example, PTL 1 proposes a technique for determining correctness of operation of a device in a system to be analyzed, based on system call performance information of an OS run in the device. The system call is a mechanism for a program to use resources managed by the OS, and the system call performance information of PTL 1 includes a system call name, an argument, and the like. In PTL 1, it is determined that a device corresponding to system call performance history matching a malicious pattern has a security problem.

For example, PTL 2 discloses a technique for generating a data transfer path, based on program operation information in which an operation specification of a program is described, and verifying whether or not there is a security violation in the data transfer path according to whether or not the data transfer path matches a preset policy. In PTL 2, behavior of a program in a system to be analyzed is modelized as a data transfer path to thereafter determine whether or not there is a security violation in the data transfer path.

### CITATION LIST

### Patent Literature

[PTL 1] JP 2019-028670 A

[PTL 2] JP 2005-196728 A

### SUMMARY

### Technical Problem

In the technique disclosed in PTL1, it is possible to determine correctness of operation of the device, based on a process performed by an application operating in the system. However, PTL 1 has an issue that correctness of data handling in the system which is a security problem not attributable to an attack or a failure cannot be determined.

In the technique disclosed in PTL 2, the data transfer path is generated based on information in which the operation specification of the program is described. The “information in which the operation specification of the program is described” is information including security configuration information and types of nodes and arcs created in a model, not information indicating behavior of the program in actual operation of the program. Hence, there is an issue that whether or not there is a security validation cannot be verified when data is exchanged in a data transfer path not generated based on the “information in which the operation specification is described”. At the same time, to reduce missing of data transfer paths in security risk analysis, it is necessary to describe an operation specification of the program in more detail. In this case, an issue of an increase of cost and time for security risk analysis cannot be solved.

An example object has been made to solve the issues and is to determine whether or not there is a security risk, based on an actual data flow in a system to be analyzed.

### Solution to Problem

In order to solve the issues, an aspect of the present invention is an analysis apparatus including: a receiving unit configured to receive history information related to operation history of a program operating in a system to be analyzed; a generating unit configured to generate data flow information indicating a path of data exchanged in the system to be analyzed, based on the history information; and a risk determining unit configured to perform a risk determining process for determining whether or not there is a security risk in the data flow information, based on a preset determination condition.

In order to solve the issues, another aspect of the present invention is an analysis system including an analysis apparatus including: a receiving unit configured to receive history information related to operation history of a program operating in a system to be analyzed; a generating unit configured to generate data flow information indicating a path of data exchanged in the system to be analyzed, based on the history information; and a risk determining unit configured to perform a risk determining process for determining whether or not there is a security risk in the data flow information, based on a preset determination condition.

In order to solve the issues, another aspect of the present invention is an analysis method including: receiving history information related to operation history of a program operating in a system to be analyzed; generating data flow information indicating a path of data exchanged in the system to be analyzed, based on the history information; and performing a risk determining process for determining whether or not there is a security risk in the data flow information, based on a preset determination condition.

In order to solve the issues, another aspect of the present invention is an analysis program causing a processor to execute: receiving history information related to operation history of a program operating in a system to be analyzed; generating data flow information indicating a path of data exchanged in the system to be analyzed, based on the history information; and performing a risk determining process for determining whether or not there is a security risk in the data flow information, based on a preset determination condition.

### Advantageous Effects of Invention

According to the present invention, it is possible to determine whether or not there is a security risk, based on an actual data flow in a system to be analyzed. Note that, according to the present invention, instead of or together with the above effects, other effects may be exerted.

### BRIEF DESCRIPTION OF THE DRAWINGS

FIG. 1 is a diagram illustrating an example of an operation form of an analysis system according to a first example embodiment;

FIG. 2 is a model diagram for describing paths of data exchanged in an authentication system according to the first example embodiment;

FIG. 3 is a block diagram illustrating a hardware configuration of an information processing apparatus according to the first example embodiment;

FIG. 4 is a functional block diagram illustrating a functional configuration of an analysis server according to the first example embodiment;

FIG. 5 is a sequence diagram illustrating a flow of processes in the analysis system according to the first example embodiment;

FIG. 6A is a diagram illustrating an example of a structure of a history information data table according to the first example embodiment;

FIG. 6B is a diagram illustrating an example of a structure of an access right information data table according to the first example embodiment;

FIG. 7 is a flowchart illustrating a flow of a data flow information generating process in the analysis server according to the first example embodiment;

FIG. 8 is a diagram illustrating an example of data flow information according to the first example embodiment;

FIG. 9 is a flowchart illustrating a flow of a risk determining process in the analysis server according to the first example embodiment;

FIG. 10 is a diagram illustrating an example of a GUI displaying a determination result of the risk determining process according to the first example embodiment;

FIG. 11 is an explanatory diagram illustrating an example of paths of data exchanged in a project management system according to the first example embodiment;

FIG. 12 is a diagram illustrating an example of an analysis system according to a second example embodiment; and

FIG. 13 is a functional block diagram illustrating a functional configuration of an analysis apparatus according to the second example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same or corresponding reference signs, and overlapping descriptions may hence be omitted.

The example embodiments to be described below are merely examples of a configuration that can realize the present invention. Modifications and changes can be appropriately made to each of the example embodiments below according to the configuration and various conditions of an apparatus to which the present invention is applied. All the combinations of the elements included in each of the example embodiments below are not necessarily essential to realization of the present invention, and part of the elements can be appropriately omitted. Hence, the scope of the present invention is not intended to be limited to the configurations described in the example embodiments below. Unless there is a mutual conflict, configurations each combining a plurality of configurations described in the example embodiments can also be adopted.

Descriptions will be given in the following order.
1. Overview of Example Embodiments of the Present Invention
2. First Example Embodiment
   2.1. Operation Form of Analysis System 1000
   2.2. Overview of Paths of Data Exchanged in Authentication System 3A
   2.3. Configuration of Analysis Server 1
      2.3.1. Hardware Configuration of Information Processing Apparatus such as Analysis Server 1
      2.3.2. Functional Configuration of Analysis Server 1
   2.4. Overview of Processes in Analysis System 1000
      2.4.1. Flow of Processes in Analysis System 1000
      2.4.2. Flow of Data Flow Information Generating Process in Analysis Server 1
      2.4.3. Flow of Risk Determining Process in Analysis Server 1
      2.4.4. Handling of Determination Result of Risk Determining Process
3. Example Alterations
4. Second Example Embodiment
5. Other Example Embodiments

### 1. Overview of Example Embodiments of the Present Invention

First, an overview of example embodiments of the present invention will be described.

### (1) Technical Issues

Security enhancement of systems connected to networks has been desired in recent years, and services such as vulnerability diagnosis and penetration test are provided to analyze a security risk in a system.

The vulnerability diagnosis is a method of comprehensively grasping vulnerability inherent in a system and a lack of a security function, based on known definitions of vulnerability such as SQL injection and cross-site request forgery. The penetration test is a method of analyzing whether an attack on a system based on an attack scenario created in advance can achieve the purpose of the attack, to thereby grasp realizability of damage to the system.

Through the vulnerability diagnosis, it is possible to comprehensively verify the entire system but is difficult to grasp undefined vulnerability and the like. Through the penetration test, it is possible to verify a concrete method of accessing the system and the like. However, the penetration test has a problem of an increase in cost and time to comprehensively analyze the system. To address the problems, a security risk analysis technique focusing on data handling in a system has been proposed.

For example, there has been proposed a technique for determining correctness of operation of a device in a system to be analyzed, based on system call performance information of an OS run in the device. The system call is a mechanism for a program to use resources managed by the OS, and the system call performance information includes a system call name, an argument, and the like. In this technique, it is determined that a device corresponding to system call performance history matching a malicious pattern has a security problem.

In this technique, it is possible to determine correctness of operation of the device, based on a process performed by an application operating in the system. However, there is an issue that correctness of data handling in the system which is a security problem not attributable to an attack or a failure cannot be determined.

For example, there has been disclosed a technique for generating a data transfer path, based on program operation information in which an operation specification of a program is described, and verifying whether or not there is a security violation in the data transfer path according to whether or not the data transfer path matches a preset policy. In this technique, behavior of a program in a system to be analyzed is modelized as a data transfer path to thereafter determine whether or not there is a security violation in the data transfer path.

In this technique, the data transfer path is generated based on information in which the operation specification of the program is described. The “information in which the operation specification of the program is described” is information including security configuration information and types of nodes and arcs created in a model, not information indicating behavior of the program in actual operation of the program. Hence, there is an issue that whether or not there is a security validation cannot be verified when data is exchanged in a data transfer path not generated based on the “information in which the operation specification is described”. At the same time, to reduce missing of data transfer paths, it is necessary to describe an operation specification of the program in more detail. For this reason, an issue of an increase of cost and time for security risk analysis cannot be solved.

In view of the above circumstances, in the present example embodiment, an example object is to determine whether or not there is a security risk, based on an actual data flow in a system to be analyzed.

### (2) Technical Features

In the example embodiments of the present invention, included are: a receiving unit configured to receive history information related to operation history of a program operating in a system to be analyzed; a generating unit configured to generate data flow information indicating a path of data exchanged in the system to be analyzed, based on the history information; and a risk determining unit configured to perform a risk determining process for determining whether or not there is a security risk in the data flow information, based on a preset determination condition.

According to this, it is possible to determine whether or not there is a security risk, based on an actual data flow in a system to be analyzed. Note that the above-described technical features are concrete examples of the example embodiments of the present invention, and the example embodiments of the present invention are apparently not limited to the above-described technical features.

### 2. First Example Embodiment

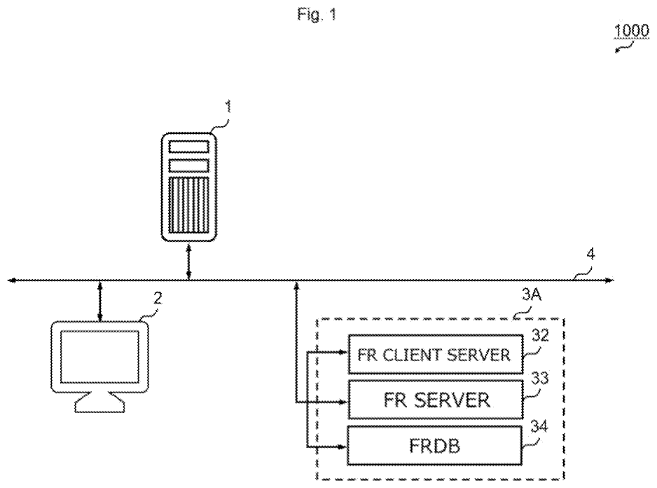

An example embodiment of the present invention will be described below with reference to FIGS. 1 to 10. In the present example embodiment, a description will be given of an analysis system configured to analyze a security risk in a system configured to provide an authentication service to be provided via a network and the like.

### 2.1. Operation Form of Analysis System 1000

First, an operation form of an analysis system 1000 according to the first example embodiment will be described. FIG. 1 is a diagram illustrating an example of the operation form of the analysis system 1000 according to the first example embodiment. As illustrated in FIG. 1, the analysis system 1000 is configured by connecting an analysis server 1, a user terminal 2, a facial recognition (FR) client server 32, a facial recognition (FR) server 33, and a facial recognition database (FRDB) 34 via a network 4.

The analysis server 1 is a server in which a program for analyzing whether or not there is a security risk in a path of data exchanged in a system to be analyzed, based on information acquired from the system to be analyzed is installed. In other words, the analysis server 1 functions as an analysis apparatus of the present example embodiment. The system to be analyzed of the present example embodiment corresponds to a system connected to the analysis server 1 via the network 4, such as an authentication system 3A, for example.

The user terminal 2 is an information processing terminal for an operator of the analysis system 1000 to operate the analysis server 1 and is implemented by a personal computer (PC) or the like. By the operator operating the user terminal 2, the user terminal 2 can be caused to display a user interface (UI) for operating the analysis server 1, and transmission/reception of information can be performed between the user terminal 2 and the analysis server 1, for example.

The FR client server 32, the FR server 33, and the FRDB 34 correspond to host terminals included in the authentication system 3A configured to provide an authentication service to authenticate a user through face authentication and the like. Details of the authentication system 3A will be described later.

### 2.2. Overview of Paths of Data Exchanged in Authentication System 3A

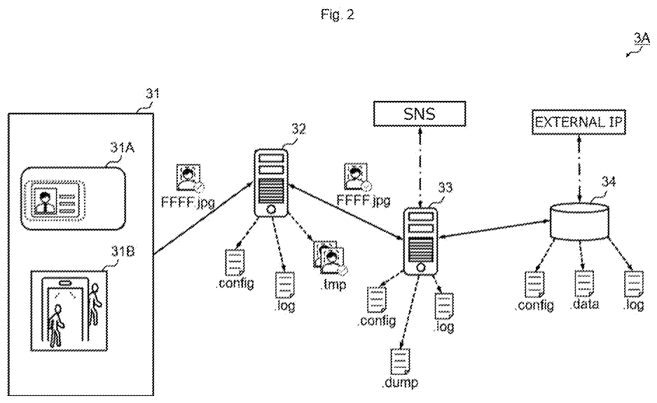

Next, an overview of paths of data exchanged in the authentication system 3A will be described with reference to FIG. 2. FIG. 2 is a model diagram for illustrating paths of data exchanged in the authentication system 3A. Note that, in the present example embodiment, a description will be given by assuming that the authentication system 3A provides an authentication service to authenticate a user by an existing face authentication technique.

The authentication system 3A includes a user information acquiring module 31, the FR client server 32, the FR server 33, and the FRDB 34. The user information acquiring module 31, the FR client server 32, the FR server 33, and the FRDB 34 are connected to each other via a network different from the network 4 (refer to FIG. 1).

As the user information acquiring module 31, an ID reader 31A capable of reading user information including a face image of a user from an IC chip integrated into a card and the like, a camera 31B configured to capture a face image of a user passing a gate as user information, and the like can be used. The user information acquired by the user information acquiring module 31 is transmitted to the FR client server 32. In the present example embodiment, the description will be given by using a path of data including the user information acquired by the ID reader 31A and/or the camera 31B as an example of the path of information exchanged in the authentication system 3A. As examples of the data, an “FFFF.jpg” file indicating the face image of the user, a data file having “.config”, “.log”, “.tmp”, “.dat”, or “.dump” as an extension are used.

Note that, in FIG. 2, exchanges of data between the user information acquiring module 31, the FR client server 32, the FR server 33, and the FRDB 34 are illustrated in solid lines. Files accessed and files generated by programs operating in the FR client server 32, the FR server 33, and the FRDB 34 are illustrated in broken lines. Further, communications of the FR server 33 and the FRDB 34 with Internet Protocol (IP) addresses outside the authentication system 3A are illustrated in alternate long and short dashed lines.

The FR client server 32 is configured to acquire user information (for example, “FFFF.jpg” and various configuration information related to the user, and the like) read by the user information acquiring module 31. The FR client server 32 is configured to generate a data file including a file identifier for uniquely identifying the data file, based on the acquired user information. At this event, the FR client server 32 is configured to generate a data file having “.log”, “.tmp”, or the like as an extension, for example. A data file having “.log” as an extension corresponds to a log data of a program operating in the FR client server 32. The FR client server 32 is also configured to generate a temporary data file having “.tmp” as an extension and including an image of “FFFF.jpg”. The FR client server 32 is configured to read a data file having “.config” as an extension. The data file having “.config” as an extension corresponds to a configuration file including data of a configuration parameter such as the IP address of the FR server 33, for example, and includes a file identifier for uniquely identifying the file.

The FR server 33 is configured to receive user information from the FR client server 32. The FR server 33 is configured to generate a data file including a file identifier for uniquely identifying the data file, based on the received user information. The FR server 33 is configured to generate a data file having “.log”, “.dump”, or the like as an extension, for example. A data file having “.log” as an extension corresponds to a log data of a program operating in the FR server 33. The FR server 33 is also configured to generate a data file having “.dump” as an extension and indicating that an abnormality has occurred in the program operating in the FR server 33. The FR server 33 is configured to read a data file having “.config” as an extension. The data file having “.config” as an extension corresponds to a configuration file including data of a configuration parameter such as the IP address of the FRDB 34, for example, and includes a file identifier for uniquely identifying the file.

Further, the FR server 33 is configured to communicate with a social networking service (SNS) implemented by information resources specified by an IP address outside the authentication system 3A.

The FRDB 34 is configured to receive the user information from the FR server 33 and stored the user information therein. The FRDB 34 is configured to generate a data file including a file identifier for uniquely identifying the data file, based on the received user information. The FRDB 34 is configured to generate a data file having “.log”, “.data”, or the like as an extension, for example. A data file having “.log” as an extension corresponds to a log data of a program operating in the FRDB 34. The FRDB 34 is also configured to generate a data file having “.dat” as an extension and including data of some kind. The FRDB 34 is also configured to read a data file having “.config” as an extension. The data file having “.config” as an extension corresponds to a configuration file including data of a configuration parameter such as the location in which the data of the FRDB 34 is stored, for example, and includes a file identifier for uniquely identifying the file.

As described above, in the authentication system 3A, programs to operate in the authentication system 3A operate to generate and exchange various data. However, the data generated or exchanged through operations of the programs to operate in the authentication system 3A are not necessarily be used for the authentication service to be provided by the authentication system 3A. Some data generated or exchanged in the authentication system 3A are considered to have a security risk as follows.

For example, in a path of data exchanged in the authentication system 3A, data including personal information such as user information may be exposed to an IP outside the authentication system 3A, such as an SNS. Such a state that data including personal information is possible to be exposed to an IP outside the authentication system 3A is not desirable from an example aspect of security. Stuck of data in which, for example, a temporary data file having “.tmp” as an extension remains in the same directory over a certain time period is not desired either from an example aspect of security. Further, a data file having “.dump” as an extension is a file generated to analyze a cause when an obstacle has occurred in the operation of a program during system development. Hence, it is not desired that a data file having “.dump” as an extension is created in an actual environment of the authentication system 3A from an example aspect of security.

Information related to data generated or exchanged through operations of the programs to operate in the authentication system 3A as that described above can be obtained in the authentication system 3A as follows. For example, the information can be obtained by an authentication program executed in the authentication system 3A acquiring a system call invoked to use resources (such as a storage medium or a memory) of each host terminal or taking a snapshot of the authentication system 3A during execution of the authentication program. The system call and the snapshot of the authentication system 3A is information generated by a program (here, the authentication program) operating in the authentication system 3A being in operation. In other words, the system call and the snapshot of the authentication system 3A correspond to history information related to operation history of the program operating in the authentication system 3A. The system call and a snapshot of a system to be analyzed, such as the authentication system 3A, will be referred to as “history information” below.

In the present example embodiment, the analysis server 1 acquires history information from the authentication system 3A and analyzes whether or not there is a security risk in a path of data exchanged in the authentication system 3A.

### 2.3. Configuration of Analysis Server 1>

Next, a configuration of the analysis server 1 of the present example embodiment will be described. Here, first, a hardware configuration of information processing apparatuses such as the analysis server 1, the user terminal 2, and the host terminals and the like included in the authentication system 3A as a system to be analyzed will be described, and then a functional configuration of the analysis server 1 will be described.

### 2.3.1. Hardware Configuration of Information Processing Apparatus such as Analysis Server 1

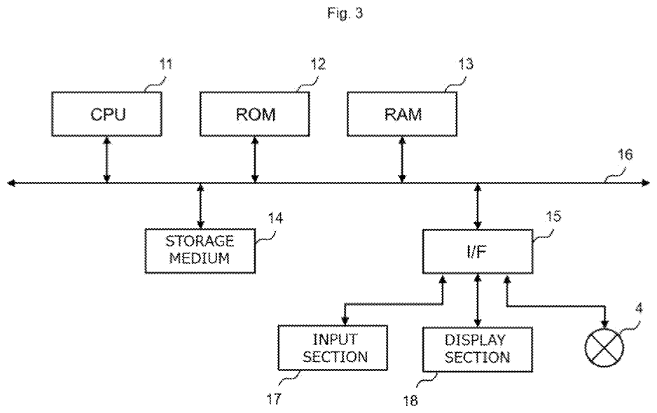

With reference to FIG. 3, the hardware configuration of the information processing apparatuses such as the analysis server 1, the user terminal 2, and the host terminals and the like included in the authentication system 3A according to the present example embodiment will be described. FIG. 3 is a block diagram illustrating a hardware configuration of the information processing apparatus.

In the information processing apparatus, a central processing unit (CPU) 11, a random access memory (RAM) 12, a read only memory (ROM) 13, a storage medium 14, and an interface (I/F) 15 are connected to each other via a bus 16. To the I/F 15, an input section 17, a display section 18, and the network 4 are connected.

The CPU 11 is a computing means and is configured to control operation of the entire information processing apparatus. The RAM 12 is a volatile storage medium capable of high-speed reading/writing of information and is used as a work region when the CPU 11 processes information. The ROM 13 is a non-volatile read-only storage medium and is configured to store therein programs such as firmware. The storage medium 14 is a non-volatile storage medium capable of reading/writing of information, such as a hard disk drive (HDD), and is configured to store therein an operating system (OS), various control programs, application programs, and the like.

The I/F 15 connects the bus 16 and various kinds of hardware, networks, and the like, for control. The input section 17 is an input apparatus, such as a keyboard and/or a mouse, for a user to input information in the information processing apparatus. The display section 18 is a display apparatus, such as a liquid crystal display (LCD), for the user to check a state of the information processing apparatus. Note that the analysis server 1 operates based on information input from the user terminal 2, and hence the input section 17 and the display section 18 can be omitted.

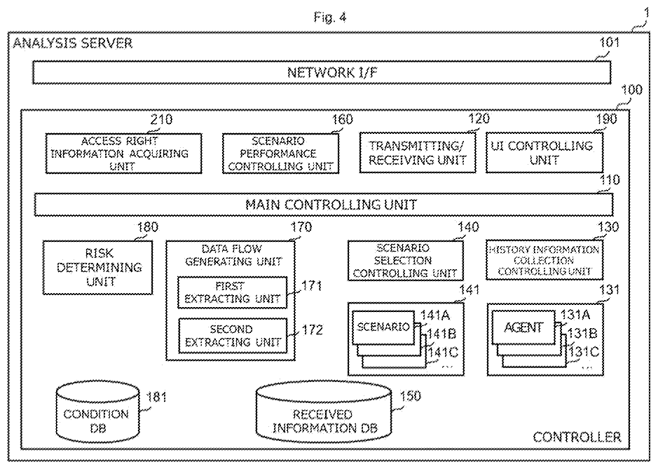

By the CPU 11 computing according to any of the programs stored in the ROM 13 or a program loaded from the storage medium 14 into the RAM 12 in such a hardware configuration, a software control section of the information processing apparatus is configured. Further, by the combination of the software control section configured as described above and hardware, a functional block implementing functions of the information processing apparatus such as a controller 100 (refer to FIG. 4) of the analysis server 1, the user terminal 2, and the host server and the like included in the authentication system 3A according to the present example embodiment is configured.

### 2.3.2. Functional Configuration of Analysis Server 1

Next, the functional configuration of the analysis server 1 will be described with reference to FIG. 4. FIG. 4 is a functional block diagram illustrating the functional configuration of the analysis server 1. As illustrated in FIG. 4, the analysis server 1 includes the controller 100 and a network I/F 101.

The controller 100 is configured to manage acquisition of history information from the system to be analyzed, generation of data flow information indicating a path of data in the system to be analyzed, security risk analysis based on the data flow information, and the like. The controller 100 is configured by a dedicated software program being installed in the information processing apparatus such as the analysis server 1. This software program corresponds to an analysis program according to the present example embodiment.

In the controller 100, a main controlling unit 110 is configured to control the entire controller 100. Hence, the main controlling unit 110 is configured to provide, to implement functions of the controller 100 described above, instructions to the units of the controller 100 to cause the units to perform processes.

A transmitting/receiving unit 120 is configured to exchange information with the system to be analyzed, via the network I/F 101. The transmitting/receiving unit 120 is configured to perform establishment of communication with the system to be analyzed, reception of information output from the system to be analyzed to the analysis server 1, and the like, for example. As one of the above functions, the transmitting/receiving unit 120 is configured to receive so-called history information including information collected by agents 131A, 131B, and 131C in the system to be analyzed, snapshots of the system to be analyzed, and the like. In other words, the transmitting/receiving unit 120 corresponds to a receiving unit configured to receive the history information.

A history information collection controlling unit 130 is configured to control performance of a collecting process for collecting the history information in the system to be analyzed by the agents 131A, 131B, and 131C each configured to perform the collecting process. Concretely, first, the history information collection controlling unit 130 installs the agents 131A, 131B, and 131C for the respective host terminals (here, the FR client server 32, the FR server 33, and the FRDB 34) included in the system to be analyzed (here, the authentication system 3A). Then, the history information collection controlling unit 130 controls initiation and termination of the collecting process for collecting history information by each of the installed agents 131A, 131B, and 131C.

The agents of the present example embodiment are software modules installed in the host terminals included in the system to be analyzed. Note that, to avoid obstructing computing performed in the host terminals, it may be designed that the agents can perform the collecting process under control of the history information collection controlling unit 130. The agents may also be designed so that, after transmission of collected history information to the analysis server 1, the agents are automatically uninstalled from the host terminals included in the system to be analyzed. A concrete procedure and the like of the collecting process by the agents will be described later.

Pieces of history information collected by the agents 131A, 131B, and 131C in the system to be analyzed are transmitted to the transmitting/receiving unit 120 via the network I/F 101. The main controlling unit 110 is configured to store the pieces of history information received by the transmitting/receiving unit 120 in a received information database (DB) 150 in association with scenarios 141A, 141B, and 141C to be described later. The main controlling unit 110 is configured to store, when access right information to be described later is already acquired, the access right information in the received information DB 150.

A scenario selection controlling unit 140 is configured to select a scenario, which is information in which a plurality of predetermined processes are described, as processes to be performed by the system to be analyzed. Concretely, the scenario selection controlling unit 140 selects any of the scenarios 141A, 141B, and 141C stored in a scenario storing unit 141, based on information received from the user terminal 2.

Note that the scenario selection controlling unit 140 may invoke a test code created for the purpose of verifying operation of the system to be analyzed, from an external apparatus connected to the analysis server 1. In this case, the test code created for the purpose of verifying operation of the authentication system 3A corresponds to a scenario.

For example, it is assumed that the scenario 141A includes descriptions of a “process for delivering user information received by the FR client server 32 to the FR server 33”, a “process for performing user authentication on user information received from the FR client server 32, in the FR server 33”, a “process for storing user information of a user authenticated in the FR server 33, in the FRDB 34 and managing the user information”, and the like.

For example, it is assumed that the scenario 141B includes descriptions of a “process in which the FR server 33 refers to user information stored in the FRDB 34”, a “process for delivering user information received by the FR client server 32 to the FR server 33”, a “process for performing user authentication, based on user information received from the FR client server 32 and user information referred to in the FRDB 34”, and the like.

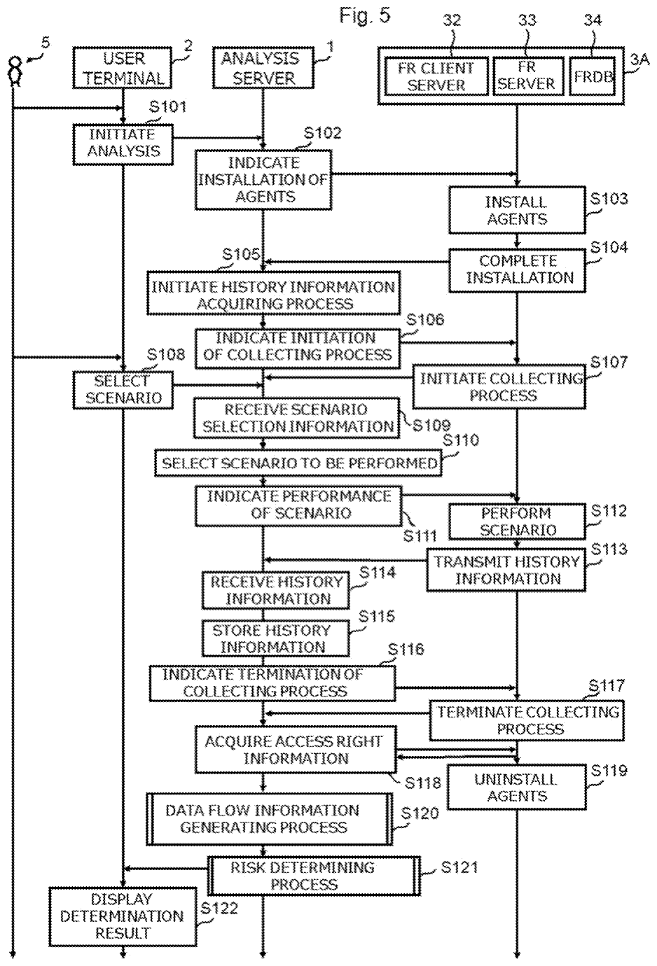

The scenario selection controlling unit 140 may generate the scenario 141C in addition to the predetermined scenarios 141A and 141B, based on information specifying a result of a process that can be performed in the system to be analyzed. The information specifying a result of a process that can be performed in the system to be analyzed is transmitted from the user terminal 2 to the analysis server 1, based on an operation on the user terminal 2 by an operator 5 (refer to FIG. 5).

A scenario performance controlling unit 160 is configured to cause the system to be analyzed to perform the scenario selected by the scenario selection controlling unit 140. Note that the scenario performance controlling unit 160 may invoke, as the scenario, the test code created for the purpose of verifying operation of the system to be analyzed from the external apparatus connected to the analysis server 1 to thereby cause the system to be analyzed, to perform the scenario. At the event of causing the system to be analyzed to perform the processes described in the scenario, the scenario performance controlling unit 160 is configured to cause, after the collecting process by the agents installed in the system to be analyzed is initiated, the system to be analyzed to initiate performing the plurality of processes described in the scenario. The scenario performance controlling unit 160 is configured to terminate, after the plurality of processes described in the scenario are completed in the system to be analyzed, the collecting process by the agents. In other words, the scenario performance controlling unit 160 functions as a process performance controlling unit of the present example embodiment.

The access right information acquiring unit 210 is configured to acquire access right information of a file exchanged in the system to be analyzed, based on the history information. For example, in a case of causing the authentication system 3A to perform the scenario 141A, the access right information acquiring unit 210 acquires information related to an access right configured for a file which a program operating in the authentication system 3A has accessed as a result of the scenario 141A being performed (referred to as “access right information” below), based on the history information and the like. Note that the agents installed in the system to be analyzed may be configured to acquire the access right information.

A data flow generating unit 170 is configured to perform a data flow information generating process for generating data flow information indicating a path of data exchanged in the system to be analyzed, based on the history information received by the transmitting/receiving unit 120. In other words, the data flow generating unit 170 corresponds to a generating unit of the present example embodiment. The data flow generating unit 170 includes a first extracting unit 171 and a second extracting unit 172.

The first extracting unit 171 is configured to extract a path including certain attribute information, from the data flow information. The certain attribute information corresponds to, for example, in a case where the data flow information is a data flow graph expressed in a graph structure, information indicating attribute of each node and each edge of the data flow graph. In this case, the path including the certain attribute information corresponds to a partial graph that is included in the data flow graph and is also including the certain attribute information. The path extracted by the first extracting unit 171 and including the certain attribute information corresponds to a first path of the present example embodiment. Note that, by the operator 5 (refer to FIG. 5) operating the user terminal 2, any attribute can be configured as the certain attribute information.

The second extracting unit 172 is configured to first divide the data flow information into a plurality of paths. In a case where the data flow information is a data flow graph expressed in a graph structure, the second extracting unit 172 is configured to divide the data flow graph into a plurality of partial graphs, based on a certain index (for example, an index representing betweenness of a network such as betweenness centrality). The second extracting unit 172 is configured to then select and extract the longest partial graph from among the plurality of partial graphs. Note that the second extracting unit 172 may select and extract a partial graph including the largest number of nodes or hosts from among the plurality of partial graphs. As described above, the second extracting unit 172 is configured to divide the data flow information into a plurality of paths and then extract the longest path or a path including the largest number of nodes or hosts from among the plurality of paths. The path extracted from the data flow information by the second extracting unit 172 corresponds to a second path of the present example embodiment. A flow of the data flow information generating process will be described later.

The risk determining unit 180 is configured to perform a risk determining process for determining whether or not there is a security risk in the data flow information, based on a determination condition stored in a condition database (DB) 181. A concrete procedure of the risk determining process will be described later.

The condition DB 181 is a database storing therein a determination condition including at least one of the following pieces of information. In the present example embodiment, the determination condition stored in the condition DB 181 includes at least one of information related to attributes of each node and each edge of the graph indicating the path of the data, information related to an access right to access the node, and information related to an operation for an information resource included in the node. The determination condition may be created based on weakness information of the system (for example, common weakness enumeration (CWE)) and the like. The determination condition stored in the condition DB 181 may include information indicating a risk index adopted in existing security risk evaluation methods such as common vulnerability scoring system (CVSS) and DREAD.

A user interface (UI) controlling unit 190 is configured to control a UI displayed in the user terminal 2, for example, perform such control as to reflect a result of the risk determining process in a UI displayed in the user terminal 2. The user terminal 2 corresponds to a display apparatus configured to display a result of the risk determining process, and the UI controlling unit 190 functions as a display controlling unit configured to cause the user terminal 2 to display a result of the risk determining process. The UI controlling unit 190 may cause the user terminal 2 to display a UI for specifying a result of a process that can be performed in the system to be analyzed.

With the configuration described above, the analysis server 1 of the present example embodiment acquires history information from the system to be analyzed and analyzes whether or not there is a security risk in a path of data exchanged in the system to be analyzed.

### 2.4. Overview of Processes in Analysis System 1000

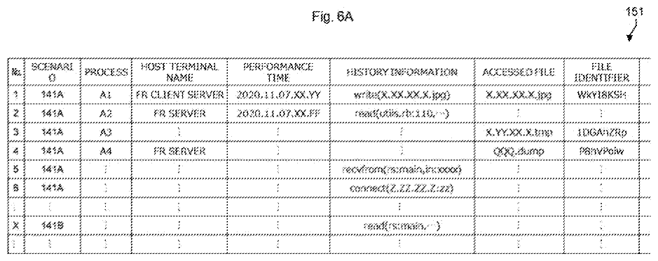

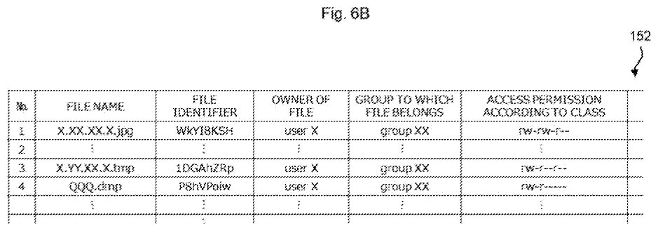

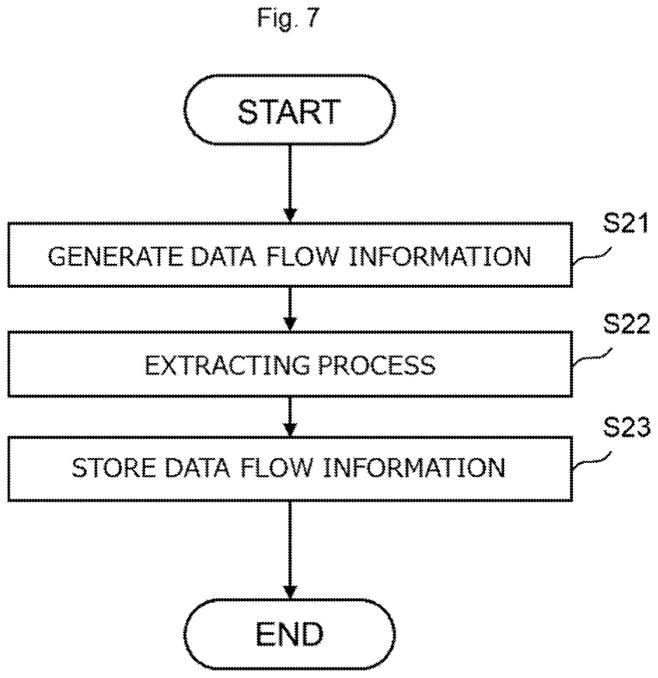

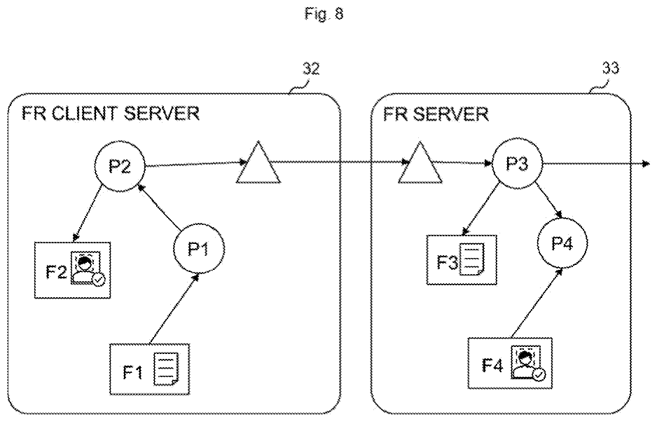

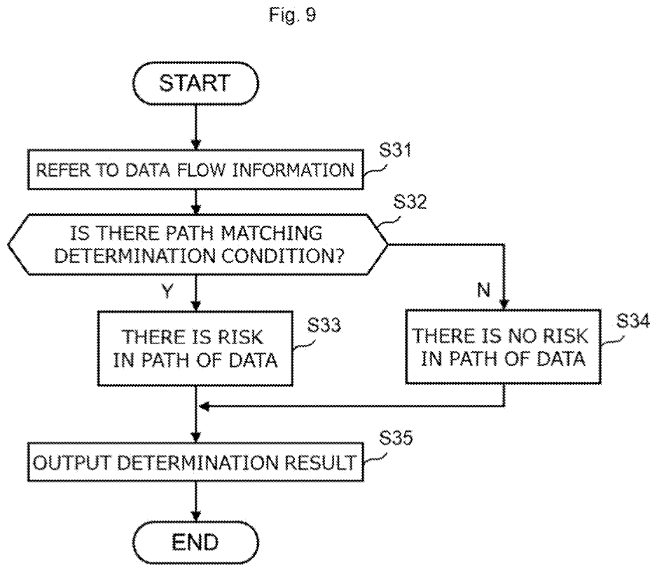

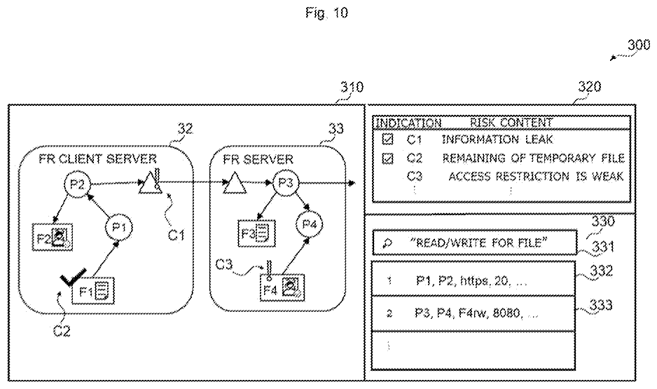

Next, an overview of processes in an analysis system 1000 of the present example embodiment will be described with reference to FIGS. 5 to 10. FIG. 5 is a sequence diagram illustrating a flow of the processes in the analysis system 1000. FIG. 6A is a diagram illustrating an example of a structure of a history information data table 151 stored in the received information DB 150. FIG. 6B is a diagram illustrating an example of a structure of an access right information data table 152 stored in the received information DB 150. FIG. 7 is a flowchart illustrating a flow of a data flow information generating process in the analysis server 1. FIG. 8 is a diagram illustrating an example of data flow information according to the present example embodiment. FIG. 9 is a flowchart illustrating a flow of the risk determining process in the analysis server 1. FIG. 10 is a diagram illustrating an example of a GUI 300 displaying a determination result of the risk determining process according to the present example embodiment.

### 2.4.1. Flow of Processes in Analysis System 1000

First, the overview of the processes in the analysis system 1000 will be described with reference to FIG. 5. In FIG. 5, the operator 5 of the analysis system 1000 performs an operation for initiating a security risk analysis in the analysis system 1000, on the user terminal 2. Here, assume that the operation for initiating a security risk analysis is performed by considering the authentication system 3A as a system to be analyzed. In step S101, the user terminal 2 transmits information indicating initiation of a security risk analysis of the authentication system 3A, to the analysis server 1.

In step S102, the analysis server 1 (history information collection controlling unit 130) indicates installation of the agents 131A, 131B, and 131C each configured to perform the collecting process for collecting history information. The analysis server 1 indicates, to each of the three host terminals included in the authentication system 3A, installation of a corresponding one of the agents 131A, 131B, and 131C.

As described above, in the present example embodiment, the FR client server 32, the FR server 33, and the FRDB 34 are included in the authentication system 3A as the host terminals. In this case, the analysis server 1 indicates installation of the agent 131A to the FR client server 32, the agent 131B to the FR server 33, and the agent 131C to the FRDB 34. In the following description, the FR client server 32, the FR server 33, and the FRDB 34 are referred to as a “host terminal of the authentication system 3A”, and the agents 131A, 131B, and 131C are referred to as an “agent”, in some cases unless otherwise discrimination is needed.

In step S103, the host terminal of the authentication system 3A installs the agent. In a case of completion of the installation of the agent, the host terminal of the authentication system 3A transmits completion notification information indicating completion of the installation of the agent, to the analysis server 1 in step S104. As a result of completion of the installation of the agent, the host terminal of the authentication system 3A is in a state of being able to initiate the collecting process.

In a case of receipt of the completion notification information, the analysis server 1 (main controlling unit 110) initiates the history information acquiring process in step S105. In a case of initiation of the history information acquiring process, the history information collection controlling unit 130 transmits a collecting process initiation indication to the host terminal of the authentication system 3A in step S106. Consequently, an initiation indication for the collecting process is transmitted from the analysis server 1 to the host terminal of the authentication system 3A in which the agent is installed.

In a case of receipt of the initiation indication for the collecting process, the collecting process for collecting history information is initiated by the agent in the host terminal of the authentication system 3A in which the agent is installed, in step S107.

The operator 5 operates the user terminal 2 to select a scenario (for example, the scenario 141A) to be performed by the authentication system 3A. In step S108, the user terminal 2 transmits scenario selection information indicating that the scenario 141A is selected, to the analysis server 1. Note that, in a case where selection of a scenario is performed on the user terminal 2 together with the operation for initiating the security risk analysis, step S101 and step S108 may be performed together.

In step S109, the transmitting/receiving unit 120 receives the scenario selection information transmitted from the user terminal 2 in step S108. Here, assume that the scenario selection information in which the scenario 141A is specified as a scenario to be performed is received. In step S110, the scenario selection controlling unit 140 selects the scenario 141A from among the scenarios stored in the scenario storing unit 141, based on the scenario selection information. Subsequently, in step S111, the scenario selection controlling unit 140 transmits a scenario performance indication in which the scenario 141A is specified as the scenario to be performed, to the host terminal of the authentication system 3A together with the scenario 141A.

In step S112, the host terminal of the authentication system 3A performs the process described in the scenario specified by the scenario performance indication. Specifically, in step S112, in the authentication system 3A, the “process for delivering user information received by the FR client server 32 to the FR server 33”, the “process for performing user authentication on user information received from the FR client server 32, in the FR server 33”, the “process for storing user information of a user authenticated in the FR server 33, in the FRDB 34 and managing the user information”, and the like described in the scenario 141A are performed. When the processes according to the scenario 141A are performed, the host terminal of the authentication system 3A transmits history information collected by the agent, to the analysis server 1 in step S113.

In step S114, the transmitting/receiving unit 120 receives the history information transmitted from the host terminal of the authentication system 3A in step S113 and delivers the history information to the main controlling unit 110. In step S115, the main controlling unit 110 stores the history information in the received information DB 150 in association with information of the scenario 141A.

After the reception and storing of the history information in step S115, the analysis server 1 (main controlling unit 110) transmits a collecting process termination indication to the host terminal of the authentication system 3A in which the agent is installed, in step S116. In step S117, the host terminal of the authentication system 3A that has received the collecting process termination indication from the analysis server 1 terminates the collecting process for collecting the history information by the agent. The analysis server 1 also terminates the history information acquiring process, based on the transmission of the collecting process termination indication.

After the termination of the history information acquiring process, in step S118, the analysis server 1 (access right information acquiring unit 210) acquires access right information of a file which a program operating in the authentication system 3A has accessed in the performance of the scenario, based on the history information. Note that each agent installed in the authentication system 3A in step S103 may be configured to acquire the access right information. The acquired access right information is stored in the received information DB 150.

Here, a structure of information stored in the received information DB 150 will be described with reference to FIGS. 6A and 6B. First, a structure of a history information data table 151 stored in the received information DB 150 will be described with reference to FIG. 6A. As illustrated in FIG. 6A, in the present example embodiment, information of a scenario and history information are stored in an associated manner. In FIG. 6A, identifiers identifying the scenarios 141A, 141B, 141C . . . stored in the scenario storing unit 141 are illustrated as information of the scenarios. However, other than these, information that can identify each process to be performed by the system to be analyzed may be adopted as information of a scenario.

In FIG. 6A, in the history information data table 151, information indicating {“scenario: 141A”, “process name: A1”, “host terminal name: FR client server”, “performance time: 2020.11.07.XX.YY”, “history information: write (X.XX.XX.X.jpg)”, “accessed file: X.XX.XX.X.jpg”, “file identifier: WkYI8KSH”} is stored in the row indicated as No. 1, as an example. In the history information data table 151, information indicating {“scenario: 141A”, “process name: A2”, “host terminal name: FR server”, “performance time: 2020.11.07.XX.FF”, “history information: read (utils.rb: 110, . . . )”} is stored in the row indicated as No. 2. In the history information data table 151, information indicating {“scenario: 141A”, “process name: A3”, “host terminal name: . . . ”, “performance time: . . . ”, “history information: . . . ”, “accessed file: X.YY.XX.X.tmp”, “file identifier: 1DGAhZRp”} is stored in the row indicated as No. 3. In the history information data table 151, information indicating {“scenario: 141A”, “process name: A4”, “host terminal name: FR server”, “performance time: . . . ”, “history information: . . . ”, “accessed file: QQQ.dump”, “file identifier: P8hVPoiw”} is stored in the row indicated as No. 4. Note that the IP address of the FR client server 32, the FR server 33, or the FRDB 34 may be stored as a host terminal name in the history information data table 151.

The information stored in the row indicated as No. 1 in the history information data table 151 corresponds to information indicating that, by a process A1 being performed as a process described in the scenario 141A by the program operating in the authentication system 3A, the operation indicated as write (X.XX.XX.X.jpg) has been performed in the FR client server 32 at XX:YY, Nov. 7, 2020 and the file “X.XX.XX.X.jpg” having a file identifier of WkYI8KSH has been accessed.

The information stored in the row indicated as No. 2 in the history information data table 151 corresponds to information indicating that, by a process A2 being performed as a process described in the scenario 141A by the program operating in the authentication system 3A, the operation indicated as read (utils.rb: 110, . . . ) has been performed in the FR server 33 at XX:FF, Nov. 7, 2020.

The information stored in the row indicated as No. 3 in the history information data table 151 corresponds to information indicating that, by a process A3 being performed as a process described in the scenario 141A by the program operating in the authentication system 3A, the file “X.YY.XX.X.tmp” having a file identifier of 1DGAhZRp has been accessed.

The information stored in the row indicated as No. 4 in the history information data table 151 corresponds to information indicating that, by a process A4 being performed as a process described in the scenario 141A by the program operating in the authentication system 3A, the file “QQQ.dump” having a file identifier of P8hVPoiw has been accessed in the FR server 33.

Next, a structure of an access right information data table 152 stored in the received information DB 150 will be described with reference to FIG. 6B. In the present example embodiment, as described above, access right information configured for a file which a program operating in the authentication system 3A has accessed as a result of a scenario being performed is stored in the access right information data table 152. FIG. 6B illustrates an example of access right information of each of “X.XX.XX.X.jpg”, “X.YY.XX.X.tmp”, and “QQQ.dump” as a file which the program operating in the authentication system 3A has accessed in the performance of the scenario 141A. Note that the access right information data table 152 illustrated in FIG. 6B illustrates an example of a configuration of access right information in UNIX (registered trademark) variants. Hence, the structure of the access right information data table 152 stored in the received information DB 150 may have a data structure other than that illustrated in FIG. 6B.

In FIG. 6B, in the access right information data table 152, information indicating {“file name: X.XX.XX.X.jpg” “file identifier: WkYI8KSH”, “file owner: user X”, “group to which file belongs: group XX”, “access permission according to class: rw-rw-r--”} is stored in the row indicated as No. 1. In the access right information data table 152, information indicating {“file name: X.YY.XX.X.tmp” “file identifier: 1DGAhZRp”, “file owner: user X”, “group to which file belongs: group XX”, “access permission according to class: w-r--r--”} is stored in the row indicated as No. 2. In the access right information data table 152, information indicating {“file name: QQQ.dump” “file identifier: P8hVPoiw”, “file owner: user X”, “group to which file belongs: group XX”, “access permission according to class: rw-r----- ”} is also stored.

The file identifier in the information stored in the access right information data table 152 is information for associating access right information stored in the access right information data table 152 and information stored in the history information data table 151. For example, in the access right information data table 152, information indicating “file identifier: WkYI8KSH” is stored in the row indicated as No. 1. Information corresponding to “file identifier: WkYI8KSH” is stored in the row indicated as No. 1 in the history information data table 151. Specifically, the access right information stored in the row indicated as No. 1 in the access right information data table 152 corresponds to information indicating access right to access the file “X.XX.XX.X.jpg” accessed in the operation indicated as write (X.XX.XX.X.jpg) performed in the FR client server 32 at XX:YY, Nov. 7, 2020 by the process A1 being performed as a process described in the scenario 141A by the program operating in the authentication system 3A.

In step S118, the analysis server 1 acquires access right information of a file identified by a file identifier stored in the history information data table 151. Note that this similarly applies to the event where the agent acquires the access right information through installation in the authentication system 3A, in step S103.

In the access permission according to class in the information stored in the access right information data table 152, permissions to read, write, and execute are configured according to class of users. For example, assume a character string stored as the access permission according to class in relation to a file of “file name: K2” is “rwxrw-r--”. In this case, in a permission configuration according to user class, read permission, write permission, and execute permission are given for the file of “file: K2”. Moreover, in this case, in a permission configuration according to group class, read permission and write permission are given for the file of “file: K2”. Moreover, in this case, in a permission configuration according to another class, read permission only is given for the file of “file: K2”.

Here, a configuration of access permission will be described by using, as an example, access right information for “file name: X.XX.XX.X.jpg” stored in the row indicated as No. 1 in the access right information indicated in the access right information data table 152 illustrated in FIG. 6B. As illustrated in FIG. 6B, for the file of “file name: X.XX.XX.X.jpg”, “file owner: user X”, “file identifier WkYI8KSH”, “group to which file belongs: group XX”, “access permission according to class: rw-rw-r--” are stored in an associated manner. This access right information indicates that the owner of the file of “file name: X.XX.XX.X.jpg” is user X and the permission configuration according to user class is applied to user X. This access right information also indicates that, for the file of “file name: X.XX.XX.X.jpg”, the permission configuration according to group class is applied to a member having a group class of group XX while the permission configuration according to another class is applied to a member not having a group class of group XX.

“access permission according to class: rw-rw-r--” associated with the file of “file name: X.XX.XX.X.jpg” indicates that read permission and write permission are given for “file name: X.XX.XX.X.jpg” in the permission configuration according to user class. In other words, user X is given read permission and write permission, which are permissions according to user class, for “file name: X.XX.XX.X.jpg”. It is also indicated that the member having a group class of group XX is given read permission and write permission for “file name: X.XX.XX.X.jpg”. It is also indicated that the member not having a group class of group XX is given read permission for “file name: X.XX.XX.X.jpg”.

As described above, the access right information configured for a file which the program operating in the authentication system 3A has accessed is stored in the access right information data table 152. When the history information and the access right information are stored in the received information DB 150, the agent is uninstalled in the host terminal of the authentication system 3A in step S119.

Next, in step S120, the analysis server 1 (data flow generating unit 170) performs the data flow information generating process. In the data flow information generating process, data flow information indicating a path of data exchanged in the system to be analyzed is generated. Details of the data flow information generating process will be described later.

Then, in step S121, the analysis server (risk determining unit 180) performs the risk determining process, based on the data flow information, and transmits a determination result to the user terminal 2. In the risk determining process, whether or not there is a security risk in the path of data indicated by the data flow information is determined based on the determination condition stored in the condition DB 181. Details of the risk determining process will be described later.

In a case of receipt of the determination result of the risk determining process, the user terminal 2 displays the determination result of the risk determining process in step S122. In the present example embodiment, the determination result of the risk determining process is displayed in the user terminal 2 as a graphical user interface (GUI) by the UI controlling unit 190 of the analysis server 1.

The operator 5 can check whether or not there is a security risk in the path of the data, from the determination result of the risk determining process displayed in the user terminal 2. In the present example embodiment, security risk analysis is performed in the procedure illustrated in FIG. 5.

As described above, in the present example embodiment, after the collecting process for collecting history information by the agent is initiated in the system to be analyzed by the history information collection controlling unit 130, the scenario performance controlling unit 160 causes the system to be analyzed to perform a scenario. Further, after the performance of the scenario to be performed by the system to be analyzed is terminated by the scenario performance controlling unit 160, the collecting process for collecting the history information by the agent is terminated by the history information collection controlling unit 130.

Hence, in the present example embodiment, it is possible to determine whether or not there is a security risk in a path of data in the system to be analyzed, based on history obtained through actual operation of a program in the system to be analyzed.

### 2.4.2. Flow of Data Flow Information Generating Process in Analysis Server 1

Next, a flow of the data flow information generating process according to the present example embodiment will be described with reference to FIGS. 7 and 8. This process corresponds to the process performed in step S120 in FIG. 5. Note that FIG. 8 illustrates partial graphs extracted through extracting processes by the first extracting unit 171 and the second extracting unit 172 as examples of the data flow information.

The main controlling unit 110 causes the data flow generating unit 170 to perform the data flow information generating process, based on the information stored in the received information DB 150. In step S21, the data flow generating unit 170 generates the data flow information, based on the information stored in the received information DB 150, for example, the history information data table 151 and the access right information data table 152 (refer to FIGS. 6A and 6B). The data flow information generated by the data flow generating unit 170 corresponds to information (refer to FIG. 8) such as a graph indicating a path of data exchanged in the system to be analyzed.

Note that, as described in FIGS. 6A and 6B, the information stored in the history information data table 151 is associated with the access right information stored in the access right information data table 152 by a file identifier. The data flow generating unit 170 may generate the data flow information by including therein the access right information corresponding to the file identifier included in the history information data table 151. In this case, first, the data flow generating unit 170 refers to the access right information data table 152 and acquires access right information of the data file corresponding to the file identifier included in the history information data table 151. Subsequently, the data flow generating unit 170 associates the access right information acquired from the access right information data table 152 with the data file to generate the data flow information.

Alternatively, the data flow generating unit 170 may generate the data flow information by including therein information specifying access right information of the data file corresponding to the file identifier included in the history information data table 151. In this case, the data flow generating unit 170 generates the data flow information by including, for example, a path specifying the access right information corresponding to the file identifier included in the history information data table 151 of the access right information included in the access right information data table 152.

In step S22, the first extracting unit 171 and the second extracting unit 172 perform an extracting process for extracting a certain path, on the data flow information generated by the data flow generating unit 170.

For example, the first extracting unit 171 extracts a path including certain attribute information from the data flow information, as a partial graph. For example, the second extracting unit 172 extracts a path having a certain length, from the data flow information, as a partial graph. Further, the data flow information generated by the data flow generating unit 170 may be stored in the analysis server 1.

FIG. 8 illustrates a data flow graph, which is an example of the data flow information generated by the data flow generating unit 170. The data flow graph illustrated in FIG. 8 is information expressed by a set of nodes including information resources such as files F1 to F4 and edges linking two or more different nodes. Assume that data of “FFFF.jpg” in FIG. 2 is included in the files F2 and F4 in FIG. 8. For example, in the FR client server 32, as a result of a process P2, the file F2 including the data of “FFFF.jpg” is generated. In the FR server 33, the file F4 including the data of “FFFF.jpg” is read in a process P4.

As described above, in the present example embodiment, information (data flow information) corresponding to a path of data based on history obtained through actual operation of the program in the system to be analyzed is generated. When data of a certain attribute is selected by the user terminal 2 being operated by the operator 5, the first extracting unit 171 extracts a flow of data related to the selected data. This makes it easier for the operator 5 to visually identify the path of the data. Further, since flows of data likely to be highly associated with the data selected by the operator 5 are extracted by the first extracting unit 171 and the second extracting unit 172, the operator 5 need not view data less associated with the selected data. Hence, the operator 5 can recognize the flow of the data in actual operation of the program in the system to be analyzed.

### 2.4.3. Flow of Risk Determining Process in Analysis Server 1

Next, a flow of the data flow information generating process according to the present example embodiment will be described with reference to FIGS. 9 to 10. This process corresponds to the process performed in step S121 in FIG. 5.

The main controlling unit 110 causes the risk determining unit 180 to perform the risk determining process, based on the data flow information generated by the data flow generating unit 170. In step S31, the risk determining unit 180 refers to the data flow information generated by the data flow generating unit 170. Note that the data flow information referred to by the risk determining unit 180 also includes paths extracted from the data flow information in the extracting processes by the first extracting unit 171 and the second extracting unit 172 (partial graphs when the data flow information is a data flow graph).

Subsequently, in step S32, the risk determining unit 180 determines whether or not a path matching the determination condition stored in the condition DB 181 is included in the data flow information referred to in step S31. As described above, the condition DB 181 includes at least one of the information related to attributes of each node and each edge of the graph indicating the path of the data, the information related to an access right to access the node, and the information related to an operation for an information resource included in the node. The determination condition may be created based on weakness information of the system (for example, common weakness enumeration (CWE)) and the like. Information indicating a risk index adopted in CVSS, DREAD, and the like may be included in the condition DB 181.

In the present example embodiment, for example, a determination condition for determining that there is a risk when a file having an extension of “.tmp” is not deleted and a determination condition for determining that there is a risk when access restriction for a file is weak, may be stored in the condition DB 181. A determination condition for determining that there is a risk when a communication protocol is not encrypted may also be stored in the condition DB 181.

Note that, in a case where the data flow information including a path for specifying the access right information corresponding to the file identifier included in the history information data table 151 and the like is generated, the risk determining unit 180 may first acquire the access right information corresponding to information specifying the access right information from the access right information data table 152 and then perform the risk determining process.

In step S33, when a path matching the determination condition stored in the condition DB 181 is included in the data flow information (S32/Y), the risk determining unit 180 determines that there is a security risk in the path of the data indicated by this data flow information.

In step S34, when a path matching the determination condition stored in the condition DB 181 is not included in the data flow information (S32/N), the risk determining unit 180 determines that there is no security risk in the path of the data indicated by this data flow information.

Then, in step S35, the risk determining unit 180 delivers a determination result in step S33 or step S34 to the main controlling unit 110 and terminates this process.

The main controlling unit 110 delivers the determination result received from the risk determining unit 180 to the UI controlling unit 190. The UI controlling unit 190 generates information to display a GUI 300 as that illustrated in FIG. 10, based on the determination result received from the main controlling unit 110 and transmits the information to the user terminal 2.

### 2.4.4. Handling of Determination Result of Risk Determining Process

Next, handling of a determination result of the risk determining process according to the present example embodiment will be described with reference to FIG. 10. FIG. 10 illustrates an example of the GUI 300 including a graph panel 310 displaying a data flow graph together with information in which paths of data determined to have a risk can be recognized, as the determination result of the risk determining process by the risk determining unit 180. Assume that, when information is transmitted from the FR client server 32 to the FR server 33, a communication protocol from the FR client server 32 is not encrypted. In this case, the risk determining unit 180 determines that there is a risk of information leak in the path of the data between the FR client server 32 and the FR server 33. Then, the GUI 300 including a warning indication Cl is displayed in the user terminal 2.

For example, assume a state where the file F1 having an extension of “.tmp” among data files managed by the FR client server 32 is not deleted. In this case, the data file to be deleted is remaining in the FR client server 32, and hence the risk determining unit 180 determines that there is a risk. Then, the GUI 300 including a caution indication C2 is displayed in the user terminal 2.

For example, assume that the process P4 for performing reading and writing on a file is performed on the file F4 having an extension of “FFFF.jpg” among the data files managed by the FR server 33. In this case, in the FR server 33, access restriction for the file F4 is weak, which may cause leak of important information, and hence the risk determining unit 180 determines that there is a risk. Then, the GUI 300 including a warning indication C3 is displayed in the user terminal 2.

Note that the GUI 300 may be configured to include a risk evaluation panel 320 and a navigation panel 330 in which the determination result of the risk determining process is displayed as character information.

For example, in the risk evaluation panel 320, character information indicating the determination result that there is a risk of information leak is displayed in the row for the warning indication C1, character information indicating the determination result that there is a risk of temporary file remaining is displayed in the row for the caution indication C2, and character information indicating the determination result whether or not there is a risk related to access restriction being weak is displayed in the row for the warning indication C3. The warning indication C3 in the graph panel 310 may be configured to be highlighted when the operator 5 operates the user terminal 2 to operate the row for the warning indication C3 in the risk evaluation panel 320.

The navigation panel 330 includes a sort button 331 capable of searching by the operator 5 specifying information such as a certain process or file, for example, “reading/writing of file”, and path specifying buttons 332 and 333 each configured to display a result of extraction of a path including the process or file specified using the sort button 331, from the data flow information. The warning indication C3 in the graph panel 310 including the file F4 and the process P4, which are in the path displayed in the path specifying button 333, may be configured to be highlighted when the operator 5 operates the user terminal 2 to operate the path specifying button 333 in the navigation panel 330.

As described above, in the present example embodiment, history information related to operation history of the program operating in the system to be analyzed is acquired, and the data flow information indicating the path of data exchanged in the system to be analyzed is generated. Then, whether or not there is a security risk in the path of the data indicated by the data flow information is determined based on the preset determination condition. Hence, in the present example embodiment, it is possible to comprehensively acquire information related to behavior of the program in actual operation of the program and determine whether or not there is a security risk in a path of the data, such as correctness of handling of the data.

In the present example, a process to be performed by the system to be analyzed is specified in advance as a scenario, and the system to be analyzed is caused to perform the process according to the scenario. Hence, it is possible to determine, after the amount of data collected for the risk determining process is reduced, what kind of risk is present in performance of a specific process in the system to be analyzed.

Further, by operating a GUI displayed in a user terminal or the like to specify a certain process or file by an operator, a determination result of the risk determining process can be displayed. This enables easy specification of a part determined to have a risk in a path of data exchanged in the system to be analyzed. Hence, it is easier to modify the part determined to have a risk, which can further reduce security risks in the system to be analyzed.

### 3. Example Alterations

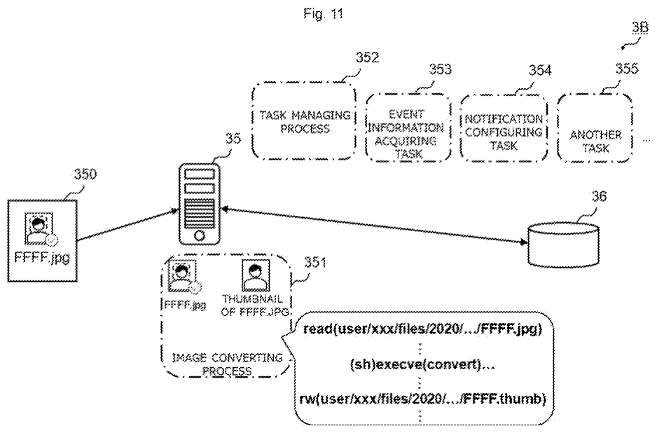

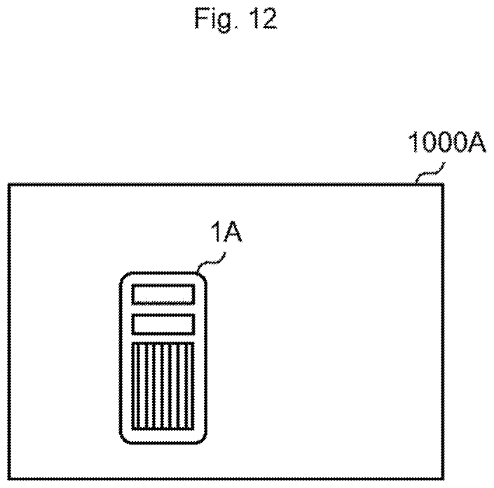

Next, operation in a case of using, instead of the authentication system 3A, a project management system 3B configured to provide a progress management service for a project to be the system to be analyzed will be described as an example alteration of the present example embodiment with reference to FIG. 11. FIG. 11 is an explanatory diagram illustrating an example of paths of data exchanged in the project management system 3B. Note that a description will be given by assuming that progress management of a project related to a user corresponding to user information 350 is performed in the example illustrated in FIG. 11. In the example illustrated in FIG. 12, assume that an image converting process 351 for generating a thumbnail image, based on the user information 350 and a task managing process 352 are performed according to the scenario 141C (refer to FIG. 4) and the analysis server 1 receives history information through communication with the project management system 3B.

Note that the project management system 3B includes a project management server 35 and a project management database (DB) 36. Also assume that the project management server 35 and the project management DB 36 are connected to the analysis server 1 via the network 4. Further, the project management server 35 and the project management DB 36 correspond to host terminals included in the project management system 3B.

In the present example alteration, assume, for example, that information specifying operation of “managing project progress related to a user by the project management system 3B” is transmitted as information specifying a result of a process that can be performed in the system to be analyzed, from the user terminal 2 to the analysis server 1. In this case, the scenario selection controlling unit 140 may generate the scenario 141C in which a “process for receiving user information”, a “process for generating a thumbnail image from received user information”, a “process for performing task management of a project related to the user specified by user information”, and the like are sequentially described and store the scenario 141C in the scenario storing unit 141.

In a case of receipt of the user information 350, the image converting process 351 and the task managing process 352 are initiated in the project management server 35. In the image converting process 351, a process for converting an image of “FFFF.jpg” included in the user information 350 to a thumbnail image is performed.

As illustrated in FIG. 12, the analysis server 1 receives
“read(user/xxx/files/2020/IFFFF jpg)”, . . . , “(sh)execve(convert) . . . ”, . . . ,
“rw(user/xxx/files/2020//FFFF.thumb)”, . . . , as history information at the time of performance of the image converting process 351 by the project management server 35. Then, in the analysis server 1, data flow information in performance of the image converting process 351 is generated as described in <2.4.>, and the risk determining process is performed on the generated data flow information.

In the task managing process 352, an event information acquiring task 353, a notification configuring task 354, and another task 355 are performed as sub-tasks. The event information acquiring task 353 is a task for acquiring various kinds of event information, such as a meeting and deadline for a project related to the user corresponding to the user information 350, from the project management DB 36. The notification configuring task 354 is a task for configuring notification of information related to a project managed in the task managing process 352, to the terminal of the user corresponding to the user information 350.

The event information acquiring task 353, the notification configuring task 354, and the other task 355 are tasks performed by accessing information resources different from those for the image converting process 351 in the project management server 35. Hence, the analysis server 1 generates data flow information in performance of the task managing process 352 as described in <2.4.>, and performs the risk determining process on the generated data flow information. Note that, in the GUI 300, a determination result of the risk determining process related to the task managing process 352 may be displayed for each of the event information acquiring task 353, the notification configuring task 354, and the other task 355.

### 4. Second Example Embodiment

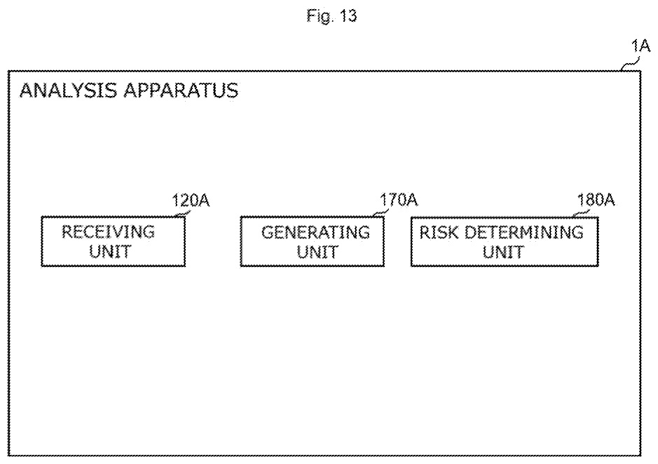

Next, a second example embodiment of the present invention will be described with reference to FIGS. 12 and 13. The above-described first example embodiment is a concrete example embodiment, whereas the second example embodiment is a more generalized example embodiment. According to the second example embodiment below, similar technical effects to those of the first example embodiment are exerted.

### 4.1. Configuration and Operation Example of Analysis Apparatus 1A

FIG. 12 is a block diagram illustrating an example of a schematic configuration of an analysis apparatus 1A according to the second example embodiment of the present invention. As illustrated in FIG. 12, an analysis system 1000A includes the analysis apparatus 1A.

### 4.2. Configuration of Analysis Apparatus 1A

FIG. 13 is a block diagram illustrating an example of a schematic configuration of the analysis apparatus 1A according to the second example embodiment. The analysis apparatus 1A includes a receiving unit 120A, a generating unit 170A, and a risk determining unit 180A.

The receiving unit 120A is configured to receive history information related to operation history of a program operating in the system to be analyzed. The generating unit 170A is configured to generate data flow information indicating a path of data exchanged in the system to be analyzed, based on the history information received by the receiving unit 120A. The risk determining unit 180A is configured to perform a risk determining process for determining whether or not there is a security risk in the data flow information generated by the generating unit 170A, based on a preset determination condition.

### Relationship with First Example Embodiment

As an example, the analysis apparatus 1A according to the second example embodiment may perform the operations of the analysis server 1 according to the first example embodiment. Similarly, as an example, the analysis system 1000A according to the second example embodiment may be configured similarly to the analysis system 1000 according to the first example embodiment. In this case, the descriptions of the first example embodiment are also applicable to the second example embodiment. Note that the second example embodiment is not limited to the above example.

### 5. Other Example Embodiments

Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

For example, the steps in the processing described in the Specification may not necessarily be executed in time series in the order described in the corresponding sequence diagram. For example, the steps in the processing may be executed in an order different from that described in the corresponding sequence diagram or may be executed in parallel. Some of the steps in the processing may be deleted, or more steps may be added to the processing.

An apparatus including the constituent elements of the analysis server 1 (for example, elements corresponding to the respective units included in the controller 100) described in the Specification may be provided. Moreover, methods including processing of the constituent elements may be provided, and programs for causing a processor to execute processing of the constituent elements may be provided. Moreover, non-transitory computer readable recording media (non-transitory computer readable media) having recorded thereon the programs may be provided. It is apparent that such apparatuses, modules, methods, programs, and non-transitory computer readable recording media are also included in the present invention.

The whole or part of the example embodiments disclosed above can be described as, but not limited to, the following supplementary notes.

### (Supplementary Note 1)

An analysis apparatus comprising:
a receiving unit configured to receive history information related to operation history of a program operating in a system to be analyzed;
a generating unit configured to generate data flow information indicating a path of data exchanged in the system to be analyzed, based on the history information; and
a risk determining unit configured to perform a risk determining process for determining whether or not there is a security risk in the data flow information, based on a preset determination condition.

### (Supplementary Note 2)

The analysis apparatus according to supplementary note 1, comprising
a history information collection controlling unit configured to control performance of a collecting process for collecting the history information in the system to be analyzed, by an agent configured to perform the collecting process.

### (Supplementary Note 3)

The analysis apparatus according to supplementary note 2, comprising
a process performance controlling unit configured to cause the system to be analyzed to perform a plurality of processes predetermined, wherein
the process performance controlling unit and the history information collection controlling unit are configured to
   cause, after the collecting process by the agent is started, the system to be analyzed to start performance of the plurality of processes, and
   terminate, after the performance of the plurality of processes by the system to be analyzed is terminated, the collecting process by the agent.

### (Supplementary Note 4)

The analysis apparatus according to any one of supplementary notes 1 to 3, wherein the generating unit includes
a first extracting unit configured to extract a first path including certain attribute information from the data flow information.

### (Supplementary Note 5)

The analysis apparatus according to any one of supplementary notes 1 to 4, wherein the generating unit includes
a second extracting unit configured to divide the data flow information into a plurality of paths, based on a certain index.

### (Supplementary Note 6)

The analysis apparatus according to supplementary note 5, wherein the second extracting unit is configured to extract a longest path as a second path from among the plurality of paths.

### (Supplementary Note 7)

The analysis apparatus according to any one of supplementary notes 1 to 6, comprising
an access information collection unit configured to collect access right information related to an access right to access a file concerned with the operation history of the program, based on the history information.

### (Supplementary Note 8)

The analysis apparatus according to supplementary note 7, wherein the generating unit is configured to generate the data flow information, based on the history information, the access right information, and process performance instruction information for causing the system to be analyzed to perform a plurality of processes predetermined.

### (Supplementary Note 9)

The analysis apparatus according to any one of claims 1 to 8, wherein the risk determining unit is configured to determine whether or not there is a security risk in a path of data corresponding to the data flow information, based on whether or not a path matching the determination condition is included in the data flow information, in the risk determining process.

### (Supplementary Note 10)

The analysis apparatus according to any one of supplementary notes 1 to 9, comprising
a display controlling unit configured to cause a display apparatus to display a result of the risk determining process.

### (Supplementary Note 11)

The analysis apparatus according to any one of supplementary notes 1 to 10, wherein the generating unit is configured to generate the data flow information, based on a piece of history information including history related to a process specified by a user as a process to be performed by the system to be analyzed, in the history information.

### (Supplementary Note 12)

The analysis apparatus according to any one of supplementary notes 1 to 11, wherein the history information is information related to a system call invoked by the program.

### (Supplementary Note 13)

The analysis apparatus according to any one of supplementary notes 1 to 12, wherein the history information is information obtained by taking a snapshot of the system to be analyzed while the program is in operation.

### (Supplementary Note 14)

The analysis apparatus according to any one of supplementary notes 1 to 13, wherein the determination condition includes at least one of information related to attributes of a node and an edge of a graph indicating the path of the data, information related to an access right to access the node, and information related to an operation for an information resource included in the node.

### (Supplementary Note 15)

An analysis system comprising
the analysis apparatus according to any one of claims 1 to 14.

### (Supplementary Note 16)

An analysis method comprising:
receiving history information related to operation history of a program operating in a system to be analyzed;
generating data flow information indicating a path of data exchanged in the system to be analyzed, based on the history information; and
performing a risk determining process for determining whether or not there is a security risk in the data flow information, based on a preset determination condition.

### (Supplementary Note 17)

An analysis program causing a processor to execute:
receiving history information related to operation history of a program operating in a system to be analyzed;
generating data flow information indicating a path of data exchanged in the system to be analyzed, based on the history information; and
performing a risk determining process for determining whether or not there is a security risk in the data flow information, based on a preset determination condition.

### INDUSTRIAL APPLICABILITY

It is possible to determine whether or not there is a security risk, based on a data flow in a system to be analyzed.

### REFERENCE SIGNS LIST

1 Analysis Server
1A Analysis Apparatus
2 User Terminal
3A Authentication System
3B Project Management System
4 Network
5 Operator
14 Storage Medium
15 Interface (I/F)
16 Bus
17 Input Section
18 Display Section
31 User Information Acquiring Module
31A ID Reader
31B Camera
32 FR Client Server
33 FR Server
34 FRDB
35 Project Management Server
36 Project Management DB
100 Controller
110 Main Controlling Unit
120 Transmitting/Receiving Unit
120A Receiving Unit
130 History Information Collection Controlling Unit
131A, 131B, 131C Agent
140 Scenario Selection Controlling Unit
141 Scenario Storing Unit
141A, 141B, 141C Scenario
150 Received Information DB
151 History Information Data Table
152 Access Right Information Data Table
160 Scenario Performance Controlling Unit
170 Data Flow Generating Unit
170A Generating Unit
171 First Extracting Unit
172 Second Extracting Unit
180, 180A Risk Determining Unit
181 Condition DB
190 UI Controlling Unit
210 Access Right Information Acquiring Unit
300 GUI
310 Graph Panel
320 Risk Evaluation Panel
330 Navigation Panel
331 Sort button
332, 333 Path Specifying Button
350 User Information
351 Image Converting Process
352 Task Managing Process
353 Event Information Acquiring Task
354 Notification Configuring Task
355 Another Task
1000, 1000A Analysis System

What is claimed is:

1. An analysis apparatus comprising:
a memory storing instructions; and
one or more processors configured to execute the instructions to:
receive history information related to operation history of a program operating in a system to be analyzed;
generate data flow information indicating a path of data exchanged in the system to be analyzed, based on the history information; and
perform a risk determining process for determining whether or not there is a security risk in the data flow information, based on a preset determination condition.

2. The analysis apparatus according to claim 1, wherein
the one or more processors are further configured to execute the instructions to control performance of a collecting process for collecting the history information in the system to be analyzed, by an agent configured to perform the collecting process.

3. The analysis apparatus according to claim 2, wherein
the one or more processors are further configured to execute the instructions to:
cause the system to be analyzed to perform a plurality of processes predetermined,
cause, after the collecting process by the agent is started, the system to be analyzed to start performance of the plurality of processes, and
terminate, after the performance of the plurality of processes by the system to be analyzed is terminated, the collecting process by the agent.

4. The analysis apparatus according to claim 1, wherein
the one or more processors are configured to execute the instructions to extract a first path including certain attribute information from the data flow information.

5. The analysis apparatus according to claim 1, wherein
the one or more processors are configured to execute the instructions to divide the data flow information into a plurality of paths, based on a certain index.

6. The analysis apparatus according to claim 5, wherein the one or more processors are configured to execute the instructions to extract a longest path as a second path from among the plurality of paths.

7. The analysis apparatus according to claim 1, wherein
the one or more processors are configured to execute the instructions to collect access right information related to an access right to access a file concerned with the operation history of the program, based on the history information.

8. The analysis apparatus according to claim 7, the one or more processors are configured to execute the instructions to generate the data flow information, based on the history information, the access right information, and process performance instruction information for causing the system to be analyzed to perform a plurality of processes predetermined.

9. The analysis apparatus according to claim 1, wherein the one or more processors are configured to execute the instructions to determine whether or not there is a security risk in a path of data corresponding to the data flow information, based on whether or not a path matching the determination condition is included in the data flow information, in the risk determining process.

10. The analysis apparatus according to claim 1, wherein
the one or more processors are further configured to execute the instructions to cause a display apparatus to display a result of the risk determining process.

11. The analysis apparatus according to claim 1, wherein the one or more processors are further configured to execute the instructions to generate the data flow information, based on a piece of history information including history related to a process specified by a user as a process to be performed by the system to be analyzed, in the history information.

12. The analysis apparatus according to claim 1, wherein the history information is information related to a system call invoked by the program.

13. The analysis apparatus according to claim 1, wherein the history information is information obtained by taking a snapshot of the system to be analyzed while the program is in operation.

14. The analysis apparatus according to claim 1, wherein the determination condition includes at least one of information related to attributes of a node and an edge of a graph indicating the path of the data, information related to an access right to access the node, and information related to an operation for an information resource included in the node.

15. An analysis system comprising
the analysis apparatus according to claim 1.

16. An analysis method comprising:
receiving history information related to operation history of a program operating in a system to be analyzed;
generating data flow information indicating a path of data exchanged in the system to be analyzed, based on the history information; and
performing a risk determining process for determining whether or not there is a security risk in the data flow information, based on a preset determination condition.

17. A non-transitory computer readable recording medium storing an analysis program causing a processor to execute:
receiving history information related to operation history of a program operating in a system to be analyzed;
generating data flow information indicating a path of data exchanged in the system to be analyzed, based on the history information; and
performing a risk determining process for determining whether or not there is a security risk in the data flow information, based on a preset determination condition.
